(19) United States
(12) Patent Application Publication
(10) Pub. No.: US 2026/0054670 A1
(43) Pub. Date: Feb. 26, 2026

(54) PROTECTION STRUCTURE FOR POWER STORAGE APPARATUS

(71) Applicant: TOYOTA JIDOSHA KABUSHIKI KAISHA, Toyota-shi (JP)

(72) Inventor: Masahito MORIMOTO, Okazaki-shi (JP)

(73) Assignee: TOYOTA JIDOSHA KABUSHIKI KAISHA, Toyota-shi (JP)

(21) Appl. No.: 19/271,355

(22) Filed: Jul. 16, 2025

(30) Foreign Application Priority Data
Aug. 22, 2024 (JP) 2024-140675

(51) Int. Cl. B60R 16/04; B60N 2/005; B62D 25/20; H01M 50/24; H01M 50/249

(52) U.S. Cl. CPC B60R 16/04; B60N 2/005; B62D 25/2072; H01M 50/24; H01M 50/249; H01M 2220/20

(57) ABSTRACT

A protection structure for a power storage apparatus is realized in which a non-waterproof device of the power storage apparatus is less susceptible to being adversely-affected by water. A protection structure for a power storage apparatus includes: a recessed part arranged in a vehicle in which the power storage apparatus is arranged at a position above spaced from the recessed part; a sheet member arranged so as to cover, between an edge of the battery case on the side where the non-waterproof device protrudes from the battery case and an edge of the recessed part on the side where the non-waterproof device protrudes from the battery case; in which the sheet member hangs down from the battery case.

### CROSS REFERENCE TO RELATED APPLICATIONS

This application is based upon and claims the benefit of priority from Japanese patent application No. 2024-140675, filed on Aug. 22, 2024, the disclosure of which is incorporated herein in its entirety by reference.

### BACKGROUND

The present disclosure relates to a protection structure for a power storage apparatus, for example, to a protection structure for a power storage apparatus mounted on a vehicle, with a non-waterproof device protruding frontward or rearward from a battery case.

It is preferable that a power storage apparatus has a configuration in which it is less susceptible to being adversely-affected by water. For example, a power storage apparatus of Patent Literature 1 has such a configuration that by forming a slope portion in the lower case of the battery case, water which has invaded the battery case is kept away from the battery module, whereby the battery module is is less susceptible to being adversely-affected by water.

[Patent Literature 1] Japanese Unexamined Patent Application Publication No. 2021-128925

### SUMMARY

The applicant has found the following problems. In general, for ease of maintenance of a power storage apparatus under a state in which the power storage apparatus is mounted on a vehicle, a non-waterproof device for the power storage apparatus has a protruding configuration. Therefore, it is preferable to configure a non-waterproof device of a power storage apparatus so that it is less susceptible to being adversely-affected by water under a state in which the power storage apparatus is mounted on a vehicle.

The present disclosure realizes a protection structure for a power storage apparatus in which a non-waterproof device of the power storage apparatus is less susceptible to being adversely-affected by water under a state in which the power storage apparatus is mounted on a vehicle.

According to an aspect of the present disclosure, a protection structure for a power storage apparatus mounted on a vehicle, in which a non-waterproof device protrudes frontward or rearward from a battery case, includes:
a recessed part arranged in the vehicle, in which the power storage apparatus is arranged at a position above and spaced from the recessed part; and
a sheet member arranged so as to cover, when viewed from the front-rear direction of the vehicle, between an edge of the battery case on the side where the non-waterproof device protrudes from the battery case and an edge of the recessed part on the side where the non-waterproof device protrudes from the battery case,
in which the sheet member hangs down from a position of an edge of the battery case where the non-waterproof device protrudes from the battery case, which is a position lower than that of the non-waterproof device.

It is preferable that in the aforementioned protection structure for the power storage apparatus, a lower edge of the sheet member hangs down on the side where the non-waterproof device protrudes from the battery case with respect to the recessed part.

It is preferable that in the aforementioned protection structure for the power storage apparatus,
the recessed part is formed in a floor panel of the vehicle,
a crossmember of the vehicle is arranged on the side where the non-waterproof device protrudes from the battery case with respect to the recessed part, and
a lower edge of the sheet member hangs down on the side where the non-waterproof device protrudes from the battery case with respect to the crossmember.

It is preferable that in the aforementioned protection structure for the power storage apparatus,
the wall part is arranged on the side where the non-waterproof device protrudes from the battery case with respect to sheet member, and
the lower edge of the sheet member is arranged between the wall part and the crossmember in the front-rear direction of the vehicle.

It is preferable that in the aforementioned protection structure for the power storage apparatus,
the power storage apparatus is arranged between a seat and the floor panel of the vehicle in an up and down direction of the vehicle,
the wall part is a seat trim of the vehicle, and
a lower edge of the sheet member comes in contact with the seat trim in the case where the sheet member rotated about an upper edge of the sheet member.

According to the present disclosure, it is possible to realize a protection structure for a power storage apparatus in which a non-waterproof device of the power storage apparatus is less susceptible to being adversely-affected by water under a state in which the power storage apparatus is mounted on a vehicle.

The above and other objects, features and advantages of the present disclosure will become more fully understood from the detailed description given hereinbelow and the accompanying drawings.

### BRIEF DESCRIPTION OF DRAWINGS

FIG. 1 is a simplified view showing a protection structure for a power storage apparatus according to an embodiment;

FIG. 2 is a simplified view showing a state in which water is accumulated in a recessed part of a floor panel in the protection structure for the power storage apparatus according to the embodiment;

FIG. 3 is a simplified view showing how water flows out of the recessed part of the floor panel in the protection structure for the power storage apparatus according to the embodiment; and

FIG. 4 is a simplified view showing how a non-waterproof device of the power storage apparatus is protected from water by a sheet member in the protection structure for the power storage apparatus according to the embodiment.

### DESCRIPTION OF EMBODIMENTS

Specific embodiments to which the present disclosure is applied will be described in detail below with reference to the drawings. However, the present disclosure is not limited to the following embodiments. In order to clarify the explanation, the following description and drawings are simplified as appropriate.

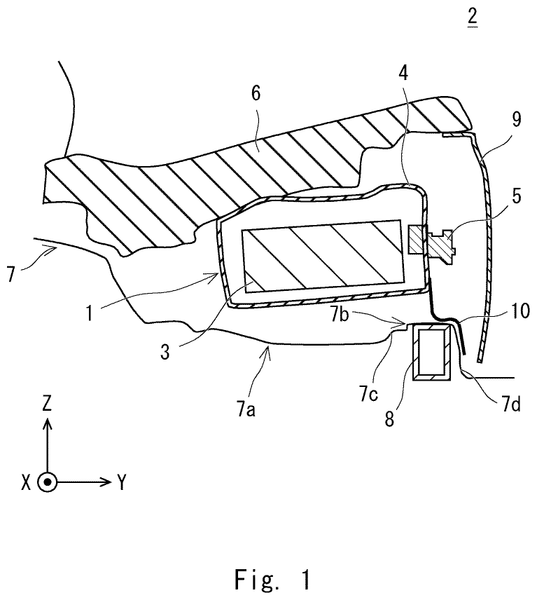

First, a protection structure for a power storage apparatus according to the present embodiment will be described. FIG. 1 is a simplified view showing a protection structure for a power storage apparatus according to the present embodiment. In the following description, a three-dimensional (XYZ) coordinate system will be used for the sake of clarity of the description. Here, for example, the X-axis positive-side corresponds to the right side of the vehicle, the X-axis negative-side corresponds to the left side of the vehicle, the Y-axis positive-side corresponds to the front side of the vehicle, the Y-axis negative-side corresponds to the rear side of the vehicle, the Z-axis positive-side corresponds to the upper side of the vehicle, and the Z-axis negative-side corresponds to the lower side of the vehicle.

The protection structure for a power storage apparatus 1 is implemented in a vehicle 2, as shown in FIG. 1. The power storage apparatus 1 extends in the X-axis direction, for example. The power storage apparatus 1 includes a battery module 3, a battery case 4, and a non-waterproof device 5.

The battery module 3 preferably includes lithium-ion batteries, nickel-hydrogen batteries, nickel-cadmium batteries, all-solid-state batteries, or the like. The battery case 4 accommodates the battery module 3, as shown in FIG. 1. The non-waterproof device 5 serves as, for example, a connection part for connection to a connector cable, and protrudes from the battery case 4 in the Y-axis positive-side.

The vehicle 2 is an electric vehicle or a hybrid vehicle, and the power storage apparatus 1 is arranged between a seat 6 and a floor panel 7, as shown in FIG. 1. The seat 6 is fixed to the floor panel 7, and is preferably a rear seat, for example.

The floor panel 7 forms a part of the body of the vehicle 2, for example. In the floor panel 7, a crossmember 8 is fixed to the Z-axis negative-side edge of the floor panel 7 to reinforce the floor panel 7 and, consequently, the body, as shown in FIG. 1. The crossmember 8 extends in the Y-axis direction, and is preferably a rectangular tubular body, for example.

In the floor panel 7, a recessed part 7a is formed at a position avoiding the crossmember 8 in order to secure the cabin space of the vehicle 2. In the illustrated example of FIG. 1, the recessed part 7a is arranged on the Y-axis positive-side and the Y-axis negative-side across the part 7b of the floor panel 7 to which the crossmember 8 is fixed.

Therefore, the part 7b of the floor panel 7 to which the crossmember 8 is fixed protrudes in the direction of the Z-axis positive-side with respect to the Z-axis negative-side bottom part of the Y-axis negative-side recessed part 7a and the Z-axis negative-side bottom part of the Y-axis positive-side recessed part 7a, as shown in FIG. 1. The power storage apparatus 1 is arranged in the Z-axis positive-side with respect to the Y-axis negative-side recessed part 7a.

A seat trim 9 hangs down from the Y-axis positive-side edge of the seat 6 to the Z-axis negative-side edge thereof, as shown in FIG. 1. The seat trim 9 is, for example, a plate having a convex shape on the Y-axis positive-side when viewed in the Y-axis direction, and partitions the space on the Z-axis negative-side of the seat 6 from the cabin space. The seat trim 9 preferably has, for example, a rectangular shape with the long side thereof in the X-axis direction when viewed in the Y-axis direction.

The Z-axis negative-side edge of the seat trim 9 is arranged, for example, in the Y-axis positive-side with respect to the part 7b of the floor panel 7 to which the crossmember 8 is fixed and with a gap between Z-axis negative-side edge of the seat trim 9 and the Z-axis negative-side bottom part of the Y-axis positive-side recessed part 7a, as shown in FIG. 1. However, the shape of the seat trim 9 may be any plate-like body capable of partitioning the space on the Z-axis negative-side of the seat 6 from the cabin space, and is not limited to the above-described shape.

In such a configuration, for example, dew condensation generated when the power storage apparatus 1 is cooled is discharged from the power storage apparatus 1 or water enters the vehicle 2 from the outside, which may cause water to accumulate in the Y-axis negative-side recessed part 7a of the floor panel 7.

At this time, when the vehicle 2 is braked, water moves in the direction of the Y-axis positive-side and is splashed up against a Y-axis positive-side side wall 7c of the Y-axis negative-side recessed part 7a of the floor panel 7 (i.e., the Y-axis negative-side side wall of the part 7b of the floor panel 7 to which the crossmember 8 is fixed), or water flown out of the Y-axis negative-side recessed part 7a is splashed up against the seat trim 9.

Water splashed up in this way comes in contact with the non-waterproof device 5 of the power storage apparatus 1, and the non-waterproof device 5 may be adversely affected by water. Therefore, in the protection structure for the power storage apparatus 1 according to the present embodiment, a sheet member 10 is arranged to serve as a cover between the Y-axis positive-side edge of the battery case 4 of the power storage apparatus 1 and the Y-axis positive-side edge of the Y-axis negative-side recessed part 7a of the floor panel 7 when viewed in the Y-axis direction, as shown in FIG. 1.

The sheet member 10 is made of resin, for example, and preferably has a substantially rectangular shape with the long side thereof in the X-axis direction when viewed in the Y-axis direction, as shown in FIG. 1. The Z-axis positive-side edge of the sheet member 10 is fixed, for example, to the Y-axis positive-side edge and the Z-axis negative-side edge of the battery case 4 of the power storage apparatus 1.

That is, the Z-axis positive-side edge of the sheet member 10 is fixed at a position on the Z-axis negative-side with respect to the non-waterproof device 5 of the battery case 4 of the power storage apparatus 1, as shown in FIG. 1. The Z-axis negative-side edge of the sheet member 10 is arranged in the Y-axis positive-side with respect to the part 7b of the floor panel 7 to which the crossmember 8 is fixed.

Therefore, the sheet member 10 hangs down from a position on the Z-axis negative-side with respect to the non-waterproof device 5 of the battery case 4 of the power storage apparatus 1, and covers the Y-axis negative-side side wall 7d of the Y-axis positive-side recessed part 7a of the floor panel 7 (in other words, the Y-axis positive-side side wall of the part 7b of the floor panel 7 to which the crossmember 8 is fixed) from the Y-axis positive-side.

That is, the sheet member 10 hangs down from the Y-axis positive-side with respect to the part 7b of the floor panel 7 to which the crossmember 8 is fixed. At this time, it is preferable that the sheet member 10 has such a length that the Z-axis negative-side edge of the sheet member 10 can be brought in contact with the seat trim 9 when the sheet member 10 is rotated about the X-axis around the Z-axis positive-side edge of the sheet member 10.

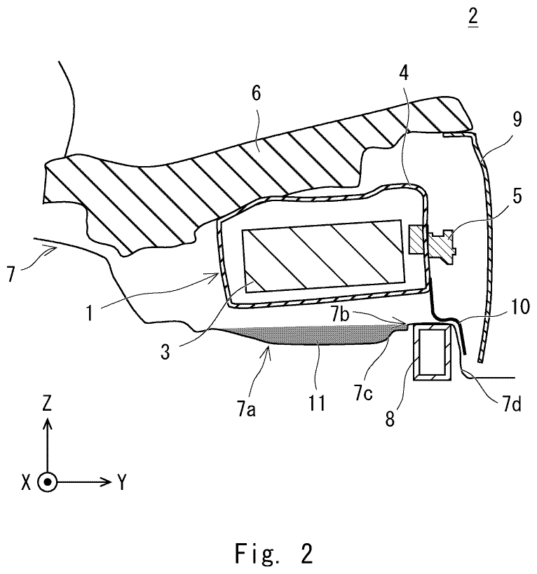

Next, the flow of protecting the non-waterproof device 5 of the power storage apparatus 1 from water by the protection structure for the power storage apparatus 1 according to the present embodiment will be described. FIG. 2 is a simplified view showing a state in which water is accumulated in the recessed part of the floor panel in the protection structure for the power storage apparatus according to the present embodiment.

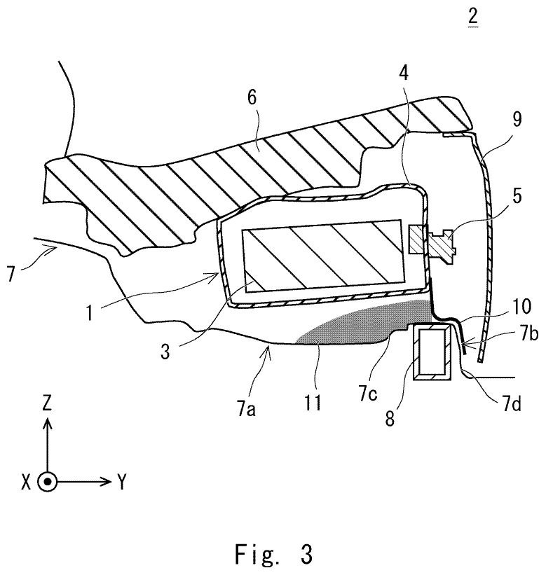

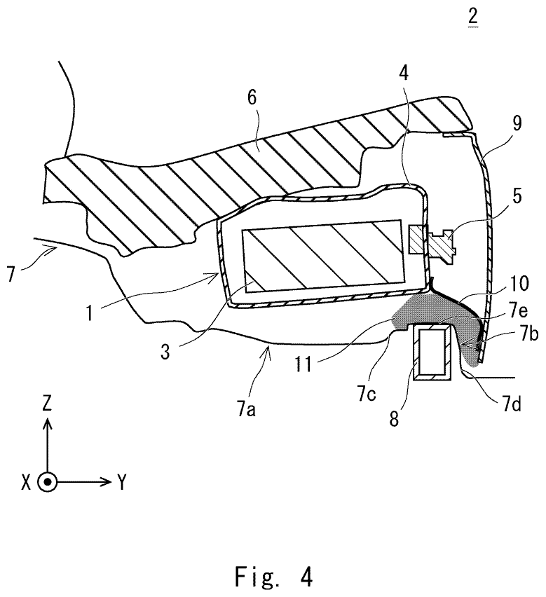

FIG. 3 is a simplified view showing how water flows out of the recessed part of the floor panel in the protection structure for the power storage apparatus according to the present embodiment. FIG. 4 is a simplified view showing how a non-waterproof device of the power storage apparatus is protected from water by the sheet member in the protection structure for the power storage apparatus according to the present embodiment.

When the vehicle 2 is braked in a state in which water 11 is accumulated in the Y-axis negative-side recessed part 7a of the floor panel 7, as shown in FIG. 2, water 11 moves in the direction of the Y-axis positive-side and flows out of the Y-axis negative-side recessed part 7a of the floor panel 7, as shown in FIG. 3.

At this time, water 11 flowing out of the Y-axis negative-side recessed part 7a of the floor panel 7 pushes the sheet member 10 in the direction of the Y-axis positive-side through the Z-axis positive-side surface 7e of the part 7b of the floor panel 7 to which the crossmember 8 is fixed, causing the sheet member 10 to rotate about the X-axis around the Z-axis positive-side edge of the sheet member 10, as shown in FIG. 4.

As a result, the energy for water 11 to move in the direction of the Y-axis positive-side decreases. Water 11, which has lost the path along which it moves in the direction of the Z-axis positive-side due to the sheet member 10, is guided along the sheet member 10 in the direction of the Z-axis negative-side while passing the part 7b of the floor panel 7 to which the crossmember 8 is fixed on the Y-axis positive-side thereof.

As a result, even when the vehicle 2 is braked causing water 11 to move in the direction of the Y-axis positive-side and splash up against the Y-axis positive-side side wall 7c of the Y-axis negative-side recessed part 7a of the floor panel 7, it is possible to suppress water 11 from coming in contact with the non-waterproof device 5 of the power storage apparatus 1 by the sheet member 10.

In addition, since the energy for water 11 to move in the direction of the Y-axis positive-side by the sheet member 10 is reduced, even in the case where water 11 comes in contact with the seat trim 9, it hardly splashes up to the non-waterproof device 5 of the power storage apparatus 1, and it is possible to suppress water 11 from coming in contact with the non-waterproof device 5 of the power storage apparatus 1.

Therefore, in the protection structure for the power storage apparatus 1 according to the present embodiment, the non-waterproof device 5 of the power storage apparatus 1 is less susceptible to being adversely-affected by water 11. It is preferable that water 11 flowing out from the Y-axis negative-side recessed part 7a of the floor panel 7 be discharged from the discharge part formed in the floor panel 7.

At this time, it is preferable that the Z-axis negative-side edge of the sheet member 10 comes in contact with the seat trim 9 when pushed in the direction of the Y-axis positive-side by water 11, as shown in FIG. 4. Thus, it is possible to suppress water 11 from splashing up in the seat trim 9, and furthermore, it is possible to suppress water 11 from coming in contact with the non-waterproof device 5 of the power storage apparatus 1.

Here, it is desirable that the sheet member 10 has enough elasticity to restore its original state (that is, the non-rotating state) by its own weight after coming in contact with the seat trim 9. In addition, it is preferable that the sheet member 10 does not come in contact with the Z-axis negative-side bottom of the Y-axis positive-side recessed part 7a of the floor panel 7 in the non-rotating state.

As described above, in the protection structure for the power storage apparatus 1 according to the present embodiment, the sheet member 10 hangs down from a position on the Z-axis negative-side with respect to the non-waterproof device 5 of the battery case 4 of the power storage apparatus 1 so at to serve as a cover between the Y-axis positive-side edge of the non-waterproof device 4 of the battery apparatus 1 and the Y-axis positive-side edge of the Y-axis negative-side recessed part 7a of the floor panel 7 when viewed in the Y-axis direction.

Thus, even when the vehicle 2 is braked causing water 11 to move in the direction of the Y-axis positive-side and splash up against the Y-axis positive-side side wall 7c of the Y-axis negative-side recessed part 7a of the floor panel 7, it is possible to suppress water 11 from coming in contact with the non-waterproof device 5 of the power storage apparatus 1 by the sheet member 10.

Moreover, since water 11 moving in the direction of the Y-axis positive-side comes in contact with the sheet member 10 and the energy for water 11 to move in the direction of the Y-axis positive-side by the sheet member 10 is reduced, even in the case where water 11 comes in contact the seat trim 9, it hardly splashes up to the non-waterproof device 5 of the power storage apparatus 1, and it is possible to suppress water 11 from coming in contact with the non-waterproof device 5 of the power storage apparatus 1. Therefore, in the protection structure for the power storage apparatus 1 according to the present embodiment, the non-waterproof device 5 of the power storage apparatus 1 is less susceptible to being adversely-affected by water 11.

Furthermore, in the case where the Z-axis negative-side edge of the sheet member 10 comes in contact with the seat trim 9 when the sheet member 10 is rotated about the X-axis around the Z-axis positive-side edge of the sheet member 10, it is possible to suppress water 11 from splashing up in the seat trim 9 by the sheet member 10, and furthermore, it is possible to suppress water 11 from coming in contact with the non-waterproof device 5 of the power storage apparatus 1.

While the non-waterproof device 5 according to the present embodiment protrudes from the battery case 4 in the direction of the Y-axis positive-side, it may protrude from the battery case 4 in the direction of the Y-axis negative-side. At this time, it is preferable that the sheet member 10 or the like be arranged in the direction of Y-axis negative-side with respect to the power storage apparatus 1.

In addition, in the above embodiment, a configuration for protecting the non-waterproof device 5 of the power storage apparatus 1 from water accumulated in the recessed part 7a of the floor panel 7 is exemplified, but the part where water accumulates may be any recessed part formed in the vehicle 2. In addition, water is made to splash up by the seat trim 9 in the configuration of the present embodiment, but the member causing water to splash up may be a wall part arranged on the side where the non-waterproof device 5 protrudes from the battery case 4 of the power storage apparatus 1 with respect to the recessed part.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A protection structure for a power storage apparatus mounted on a vehicle, in which a non-waterproof device protrudes frontward or rearward from a battery case, comprising:
a recessed part arranged in the vehicle, in which the power storage apparatus is arranged at a position above and spaced from the recessed part; and
a sheet member arranged so as to cover, when viewed from the front-rear direction of the vehicle, between an edge of the battery case on the side where the non-waterproof device protrudes from the battery case and an edge of the recessed part on the side where the non-waterproof device protrudes from the battery case,
wherein the sheet member hangs down from a position of an edge of the battery case where the non-waterproof device protrudes from the battery case, which is a position lower than that of the non-waterproof device.

2. The protection structure for the power storage apparatus according to claim 1, wherein a lower edge of the sheet member hangs down on the side where the non-waterproof device protrudes from the battery case with respect to the recessed part.

3. The protection structure for the power storage apparatus according to claim 2, wherein
the recessed part is formed in a floor panel of the vehicle,
a crossmember of the vehicle is arranged on the side where the non-waterproof device protrudes from the battery case with respect to the recessed part, and
a lower edge of the sheet member hangs down on the side where the non-waterproof device protrudes from the battery case with respect to the crossmember.

4. The protection structure for the power storage apparatus according to claim 3, wherein
the wall part is arranged on the side where the non-waterproof device protrudes from the battery case with respect to sheet member, and
the lower edge of the sheet member is arranged between the wall part and the crossmember in the front-rear direction of the vehicle.

5. The protection structure for the power storage apparatus according to claim 4, wherein
the power storage apparatus is arranged between a seat and the floor panel of the vehicle in an up and down direction of the vehicle,
the wall part is a seat trim of the vehicle, and
a lower edge of the sheet member comes in contact with the seat trim in the case where the sheet member is rotated about an upper edge of the sheet member.
